(19) United States
(12) Patent Application Publication
(10) Pub. No.: US 2009/0115666 A1
(43) Pub. Date: May 7, 2009

(54) Multi-Functional External Antenna

(76) Inventors: Thomas WULFF, North Patchogue, NY (US); Mark Duron, East Patchogue, NY (US); Russell Calvarese, Stony Brook, NY (US); Richard Knadle, Dix Hills, NY (US)

Correspondence Address: Fay Kaplun & Marcin, LLP/ Motorola, 150 Broadway Suite 702, New York, NY, 10038, US

(21) Appl. No.: 11/936,580

(22) Filed: Nov. 7, 2007

(51) Int. Cl. H01Q 1/24; H01Q 1/12

(52) U.S. Cl. 343/702; 343/878

(57) ABSTRACT

A mobile device with a multi-functional external antenna comprises a housing and an external antenna. The external antenna is disposed at least partially on the housing and conforms to the housing. The external antenna is configured to one of receive wireless data signals and transmit wireless data signals. The external antenna is further configured to conduct power signals.

### FIELD OF THE INVENTION

The present invention relates generally to a multi-functional external antenna. Specifically, the multi-functional external antenna may provide a radio frequency identification functionality, an abrasion protection, charging point contacts, a connectivity to a network, and contact points to enable transfer of data signals and power to accessories.

### BACKGROUND

A mobile unit (MU) is constantly being improved by having a smaller size and a lighter weight. While becoming smaller and lighter, the MU must also be improved by incorporating the latest state of the art features. The incorporation of the latest features may require additional components to be included in or on a housing of the MU. Additional components may also be required to improve already existing functionalities of the MU. Consequently, the overall size and weight of the MU may be increased.

The MU may also include wireless communication capabilities such as wireless network connectivity and radio frequency communication and/or wireless data capture capabilities such as radio frequency identification. The wireless communication and wireless data capture capabilities require at least one antenna to be utilized to transmit/receive electronic signals. The antennas may be located internally to a housing of the MU or as an external appendage such as a stub; whip, etc. However, running contradictory to the improvements being made to the MU, an internal antenna configuration increases the size of the overall housing and device size. The external antenna configuration also increases the size of the device while being obtuse to the housing form. The external antenna may also have reliability issues (e.g., drop, breakage, etc.).

### SUMMARY OF THE INVENTION

The present invention relates to a mobile device with a multi-functional external antenna. The mobile device comprises a housing and an external antenna. The external antenna is disposed at least partially on the housing and conforms to the housing. The external antenna is configured to one of receive wireless data signals and transmit wireless data signals. The external antenna is further configured to conduct power signals.

### DESCRIPTION OF THE DRAWINGS

FIG. 1 shows components for a coupling of a mobile unit with a mount according to an exemplary embodiment of the present invention.

FIG. 2 shows components for a coupling of a mobile unit with a charger according to an exemplary embodiment of the present invention.

FIG. 3 shows a side view of a mobile unit that includes a multi-functional external antenna according to an exemplary embodiment of the present invention.

FIG. 4 shows a perspective view of the mobile unit of FIG. 3.

FIG. 5 shows a perspective view of a mount that couples to the mobile unit of FIG. 1 according to an exemplary embodiment of the present invention.

FIG. 6 shows an assembled view of the mobile unit of FIG. 3 coupled to the mount of FIG. 5 according to an exemplary embodiment of the present invention.

FIG. 7 shows a perspective view of a charger that couples to the mobile unit of FIG. 3 according to an exemplary embodiment of the present invention.

FIG. 8 shows an assembled view of the mobile unit of FIG. 3 coupled to the charger of FIG. 7 according to an exemplary embodiment of the present invention.

FIG. 9 shows a schematic view of circuit components of the mobile unit of FIG. 3 coupled to the mount of FIG. 5 according to an exemplary embodiment of the present invention.

FIG. 10 shows an exemplary circuit for data over direct current transfers according to an exemplary embodiment of the present invention.

FIG. 11 shows a carrier circuit for data over direct current transfers according to an exemplary embodiment of the present invention.

FIG. 12 shows a first graph of signals for a data over direct current technique according to an exemplary embodiment of the present invention.

FIG. 13 shows a second graph of signals for a data over direct current technique according to an exemplary embodiment of the present invention.

FIG. 14 shows a third graph of signals for a data over direct current technique according to an exemplary embodiment of the present invention.

FIG. 15 shows a fourth graph of signals for a data over direct current technique according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a multi-functional antenna for a mobile unit (MU). Specifically, the exemplary embodiments of the present invention may illustrate various functionalities that the antenna is capable of performing. The functionalities of the antenna may further extend to incorporate features of a mount and a charger. The MU, the antenna, the mount, and the charger will be discussed in more detail below.

The MU according to the exemplary embodiments of the present invention may be used in a variety of configurations. In a first exemplary configuration, the MU may be used as a stand alone unit. As a stand alone unit, the MU may carry out functionalities of a conventional MU. For example, the antenna of the MU may be used for connectivity functionalities, radio frequency identification (RFID) functionalities, etc. As will be described in detail below, the antenna may also be used for further functionalities such as protection. In a second exemplary configuration, the MU may be used in conjunction with a mount. As will be described in detail below, the antenna may serve as conduits for energy and/or data exchange while still retaining conventional functionalities when used at different times or concurrently with the exchange. In a third exemplary configuration, the MU may be used in conjunction with a charger. As will be described in detail below, the antenna may further serve as conduits for energy and/or data exchange while still retaining the conventional functionalities when used during a charging phase.

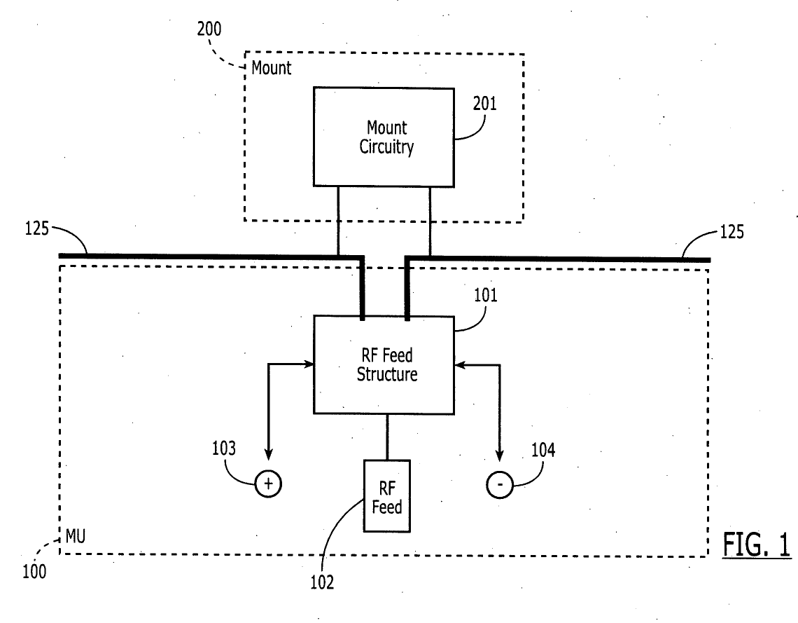

FIG. 1 shows components for a coupling of an MU 100 with a mount 200 according to an exemplary embodiment of the present invention. The coupling of the MU 100 with the mount 200 may be the second exemplary configuration discussed above. In this coupling, the mount 200 may be in electrical communication with the MU 100 via antennas 125. As will be discussed in further detail below, the antenna 125 may be equipped to transmit/receive RF signals while providing a connectivity conduit for energy and/or data exchange with the mount 200. The energy and/or data exchange may be to/from a mount circuitry 201.

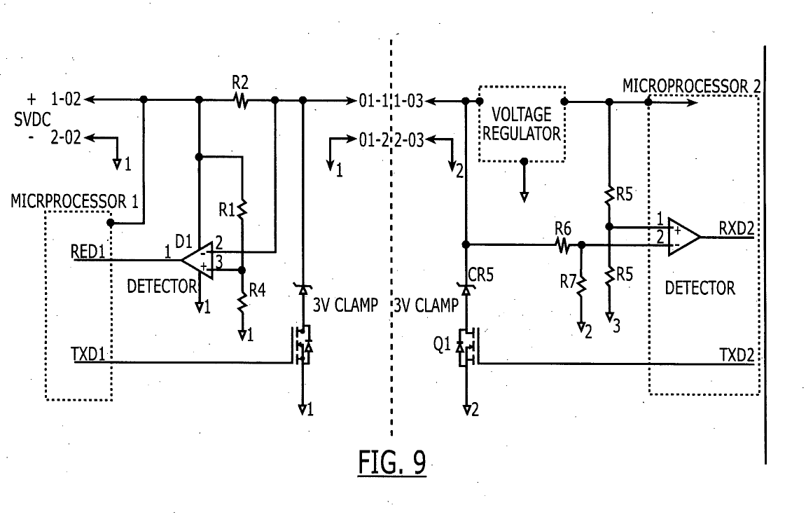

The antenna 125 may receive signals to transmit or forward received signals to an RF feed structure 101. The RF feed structure 101 may forward appropriate signals to the antennas 125 by initially receiving a signal from an RF feed 102. The RF feed 102 may be, for example, a transmitter, a receiver, a transceiver, etc. As will be discussed in further detail below, the RF feed structure 101 may transmit/receive energy and/or data from the mount 200. The energy and/or data may be transmitted/received and converted by the RF feed structure into a positive direct current (DC) circuit 103 and a negative DC circuit 104. The RF feed structure will be discussed in further detail below with reference to FIG. 9. RF chokes may be incorporated with both of the antennas 125. The RF chokes may prevent any interference with the antennas 125 from performing the conventional functionalities of wireless communications (e.g., RFID, network connectivity, etc.). That is, the RF chokes may isolate the antennas 125 from the energy and/or data exchange that may be occurring.

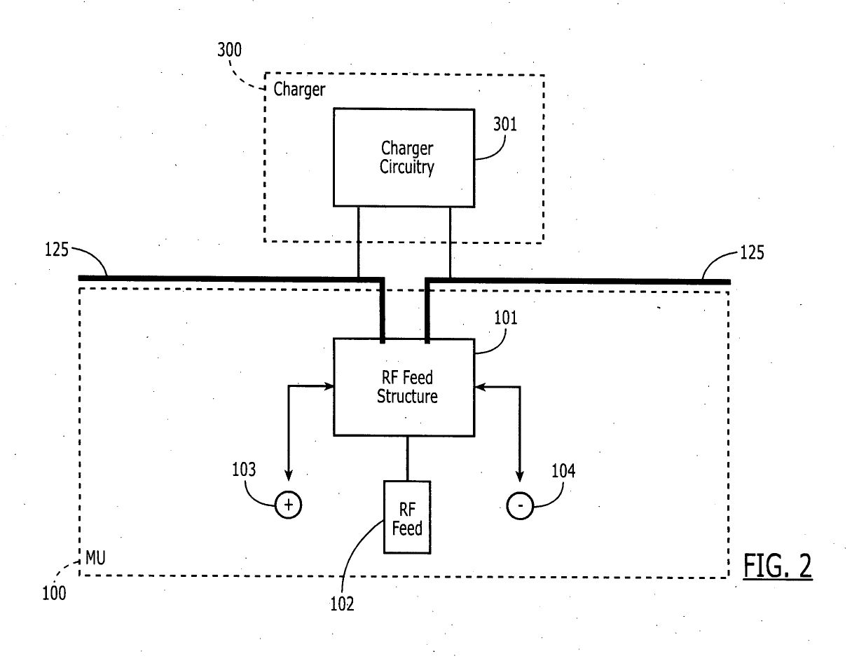

FIG. 2 shows components for a coupling of a mobile unit with a charger according to an exemplary embodiment of the present invention. The coupling of the MU 100 with the charger 300 may be the third exemplary configuration discussed above. In this coupling, the charger 300 may be in electrical communication with the MU 100 via antennas 125 to recharge an internal power supply of the MU 100 (e.g., battery). As will be discussed in further detail below, the antennas 125 may be equipped to transmit/receive RF signals while providing a charging conduit for energy and/or data exchange with the charger 300. The energy and/or data exchange may be to/from a charger circuitry 301. The MU 100 and the components may function substantially similar to the components of the MU 100 described above with reference to FIG. 1.

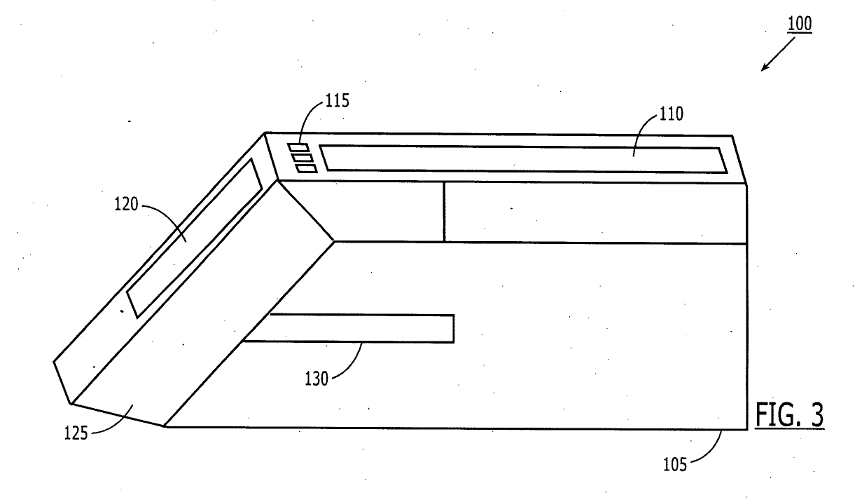

FIG. 3 shows a side view of an MU 100 that includes a multi-functional external antenna 125 according to an exemplary embodiment of the present invention. The MU 100 may be any portable electronic device that utilizes a portable power supply (e.g., battery, capacitor, super capacitor, etc.). For example, the MU 100 may be a laptop, a pager, a cell phone, a radio frequency identification device, a scanner, etc. It should be noted that the use of the MU 100 is only exemplary. That is, the exemplary embodiments of the present invention may apply to any electronic device that utilizes the antennas 125. The MU 100 may include a housing 105, a display 110, a data input arrangement 115, a scanner 120, the antennas 125, and channels 130.

The housing 105 may provide a casing in which components of the MU 100 may be at least partially disposed. That is, the components of the MU 100 may be wholly or partially within the housing 105. As discussed above with reference to FIG. 1, the MU 100 may include the RF feed structure 101 and the RF feed 102. These components may be disposed within the housing 105. The MU 100 may also include a processor, a memory, a transceiver, etc. These components may be fragile and, therefore, be entirely disposed within the housing 105. In another example, the display 110, the data input arrangement 115, the scanner 120, etc. may be disposed partially within the housing 105 so that a portion of these components are disposed on a periphery of the housing 105.

The display 110 may provide a user interface. Specifically, the user interface may be a graphical user interface (GUI). The data input arrangement 115 may be a keypad in which a user may enter various inputs. The inputs may correspond to at least one installed program or functionality of the MU 100. It should be noted that the display 110 may be a touch screen that enables a user to enter inputs thereon. That is, the data input arrangement 115 being a separate component is only exemplary. Thus, the MU 100 may include the display 110 and the data input arrangement 115, the display 110 with touch screen capabilities, or a combination thereof. It should also be noted that the data input arrangement 115 may include further keypads disposed on other peripheral areas of the housing 105 such as a side data input arrangement.

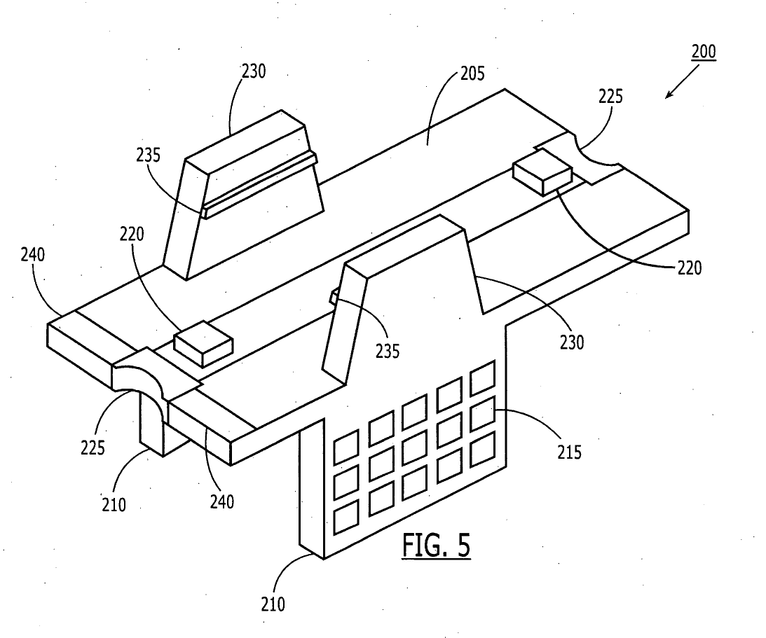

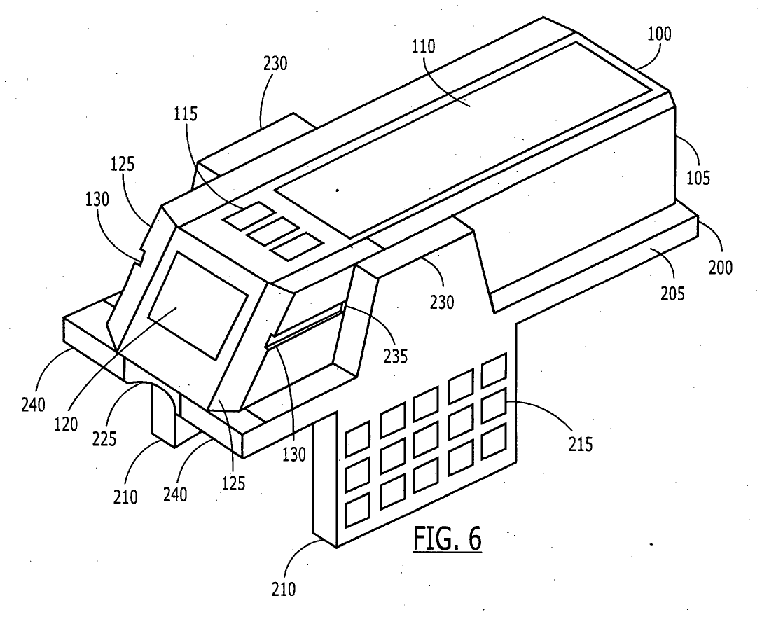

The scanner 120 may be any data capturing device. For example, the scanner 120 may be a barcode scanner (e.g., for one-dimensional or two-dimensional barcodes), an imager, a camera, etc. As discussed above, the scanner 120 may be partially disposed within the housing 105. That is, a scanning engine of the scanner 120 may be wholly disposed within the housing 105. However, those skilled in the art will understand that the scanner 120 may require a line of sight to the object that is to be scanned. Thus, a transparent window may be disposed on a periphery of the housing 105 to create the line of sight. The channels 130 may be used in conjunction with a mount that receives the MU 100 (e.g., mount 200). The mount may enable the MU 100 to be worn by a user. The mount will be discussed in further detail below with reference to FIGS. 5-6. It should be noted that the illustration of the display 110, the data input arrangement 115, and the scanner 120 is only exemplary and the MU 100 may include other components.

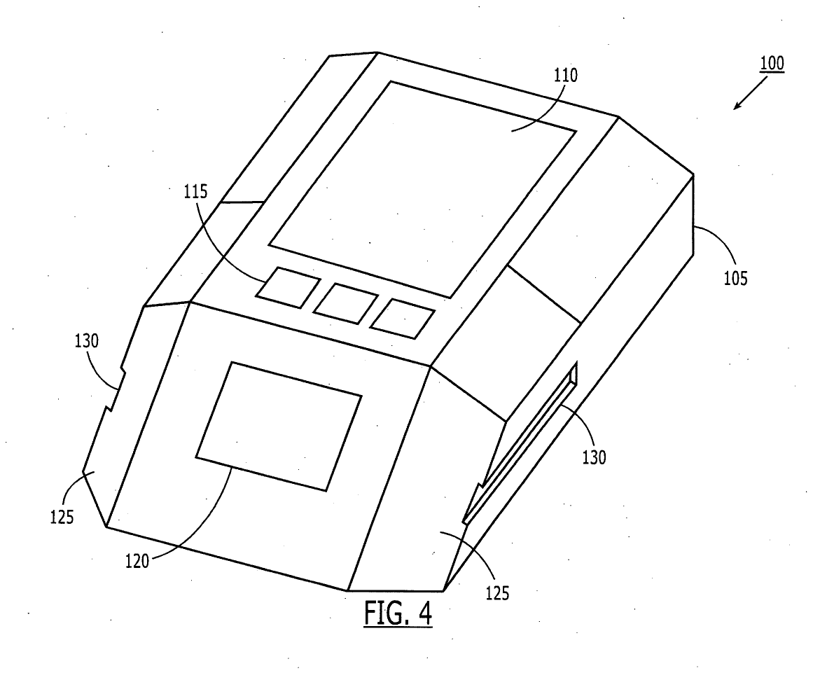

The antennas 125 may include at least one external antenna. The side view of FIG. 3 shows a single antenna 125. However, as will be discussed in detail below with reference to FIG. 4, the MU 100 may include at least two antennas 125. As illustrated, the antennas 125 may extend an entire height of a side of the housing 105. The antennas 125 may also extend a partial length of a top face of the housing 105. In addition, the antennas 125 may extend a partial length of a bottom face of the housing 105 (not shown). As will be described in greater detail below, the antennas 125 may be conformed to any shape to correspond to the shape of the housing 105 (or any portion of the housing 105).

The antennas 125 may be manufactured of a durable conducting material such as metal. The housing 105 may be manufactured of a durable insulating material such as a polymer. The antennas 125 may provide an electrical connection to relay data and/or power signals. Consequently, the housing 105 may be composed of the insulating material. The functionalities of the antennas 125 will be described in detail below with reference to FIG. 4. Furthermore, as discussed above, the antennas 125 may be electrically connected to, for example, the RF feed structure 101 disposed within the housing 105. As will be discussed in detail below, the antennas 125 may also be electrically connected to other components of the MU 100.

The antennas 125 may be disposed partially within the housing 105 or may be mounted on an external surface of the housing 105. That is, since the antennas 125 are external, a portion of the antennas 125 is disposed on a periphery of the housing. For example, in a first exemplary embodiment, the housing 105 may form the complete shape of the MU 100 and the antennas 125 may be externally mounted to the housing 105 (e.g., gluing, using mechanical fasteners, etc.). In a second exemplary embodiment, the housing 105 may be molded such that it holds the antennas 125 without the use of further fasteners. Those skilled in the art will understand that there are numerous manners by which the housing 105 and antennas 125 may be manufactured to be (or give the appearance of being) a single integrated component. According to the exemplary embodiments of the present invention, the externality of the antennas 125 may not be obtuse to the housing 105 (i.e., the antennas are not a stub, a whip, etc.). That is, the housing 105 may be molded to be configured to hold the antennas 125 in an orientation that prevent the antennas 125 from protruding, thereby creating a flush periphery for the MU 100. The antennas 125 may be disposed on the housing 105 using a variety of methods such as being insert molded, inserted mechanically during manufacture, heat staked, adhered, transfer taped, plated directly to the housing 105, etc. It should be noted that a combination of the above methods may also be used.

FIG. 4 shows a perspective view of the MU 100 of FIG. 3. That is, the perspective view of the MU 100 may again illustrate the housing 105, the display 110, the data input arrangement 115, the scanner 120, the antennas 125, and the channels 130. The perspective view additionally illustrates a relative position between the visible components on the periphery of the housing 105. The perspective view of the MU 100 further shows the two antennas 125 disposed on front edges of the housing 105 and a relative position with respect to the housing 105. The perspective view of the MU 100 also shows that two channels 130 may be disposed on opposing sides of the housing 105.

As discussed above, the antennas 125 may be oriented in a position on the housing 105 so that a flush exterior may be created for the MU 100. In addition, the material and location of the antennas 125 may provide wearing plates for the MU 100. Those skilled in the art will understand that extensive wear along the front surfaces of the housing of conventional MUs may be experienced from frequent use of the MU (e.g., handling freight, loading/unloading, etc.). Consequently, the housing of conventional MUs may be worn to a degree where the inner circuitry may become exposed.

As discussed above in the first exemplary configuration, the MU 100 may be used as a stand alone unit. That is, the MU 100 may be used as a portable electronic device. According to the exemplary embodiments of the present invention, the conducting metallic antennas 125 may also serve as wear plates on the front end to prevent wearing of the housing 105. The higher durability of the material that is used to manufacture the antennas 125 may serve to decrease the amount of wear that the MU 100 experiences. Thus, the housing 105 may not become exposed to the wearing conditions where the antennas 125 are located. Furthermore, if the MU 100 is used frequently enough that wearing of the antennas 125 occurs, the internal circuitry may still not be exposed as a layer of the housing 105 may exist underneath the antennas 125. In addition, instead of being required to completely replace the entirety of the housing 105 when wearing is experienced, the antennas 125 may be easily replaced. Those skilled in the art will understand that placing the antennas 125 in the front end of the MU 100 is only exemplary. Different MUs may experience wear in different locations and, therefore, it may be advantageous to place the antenna(s) 125 in the most troublesome wear location for the particular MU.

In any of the three exemplary configurations discussed above, the antennas 125 may also serve conventional functionalities performed by antennas. That is, the antennas 125 may transmit data signals to and/or receive data signals from another electronic device. For example, the antennas 125 may be used to connect the MU 100 to a wireless network. As discussed above, the antennas 125 may be electrically connected to a transceiver of the MU 100 such as a radio circuit, radio frequency identification engine (RFID), etc. The antennas 125 may be sized and shaped to have a proper resonate structure to function substantially similar to a conventional external antenna. Therefore, the antennas 125 may be used in RFID applications (e.g., ultra high frequency (UHF) RFID) and network applications (e.g., wide area network (WAN), local area network (LAN), private area network (PAN), global positioning system (GPS)). That is, those skilled in the art will understand that the physical characteristics of the antennas 125 (e.g., length, etc.) may be based on the frequency of the signals of which the antenna 125 is designed to transmit and/or receive. It should be noted that the antennas 125 may perform the conventional functionalities at any time. That is, the antennas 125 may send and/or receive data signals (e.g., RFID) as the stand alone unit, when the antennas 125 are being used in the second exemplary configuration (e.g., coupled to the mount 200 for energy and/or data exchange), or when the antennas are being used in the third exemplary configuration (e.g., coupled to the charger 300 for internal power supply recharging and/or data exchange).

FIG. 5 shows a perspective view of a mount 200 that couples to the MU 100 of FIG. 3 according to an exemplary embodiment of the present invention. The mount 200 may be any device that enables a user to wear the MU 100. For example, the mount 200 may be a finger mount, a wrist mount, a waist mount, etc. The mount 200 may include a dock 205, a wearing mechanism 210, a secondary data input arrangement 215, locking mechanisms 220, release mechanisms 225, docking walls 230, rails 235, and connection pads 240.

The dock 205 may provide a surface in which the MU 100 may be placed. For example, if the mount 200 is a wrist mount, the dock 205 may be a substantially flat platform designed to be disposed between the wrist of the user and the MU 100. The wearing mechanism 210 may be embodied in a variety of forms to facilitate a wearing of the MU 100 on a respective area on the user. For example, if the mount 200 is a finger mount or a wrist mount, the wearing mechanism 210 may be straps or a ring.

In another example, if the mount 200 is a waist mount, the wearing mechanism 210 may be a belt clip. Thus, the wearing mechanism 210 may be rigid, flexible, or a combination thereof depending on the location in which the MU 100 is worn.

The secondary data input arrangement 215 may be substantially similar in utility as the data input arrangement 115 of the MU 100. That is, the secondary data input arrangement 215 may further provide a data entry device for the user. Due to increasingly smaller MU sizes, the data input arrangement 115 may include relatively small keys. Thus, the secondary data input arrangement 215 may include larger keys for easier data entry by the user. Furthermore, the mount 200 may be equipped with further components to perform functionalities not included in the MU 100. Thus, the secondary data input arrangement 215 may be used for these other functionalities. It should be noted that the secondary data input arrangement 215 being disposed on the wearing mechanism 210 is only exemplary. That is, the secondary data input arrangement 215 may be disposed on any exposed location of the mount 200 after receiving the MU 100. Furthermore, the data input arrangement 215 may be a flexible keypad if disposed on, for example, a strap of a wrist mount.

The locking mechanisms 220 may provide for a secure attachment of the MU 100 when received by the mount 200. The locking mechanisms 220 may be, for example, retractable extensions that are received by slots located on corresponding areas of the MU 100. The locking mechanisms 220 may also be, for example, attaching devices such as hook and loop fasteners, snaps, buttons, etc. The release mechanisms 225 may be coupled to the locking mechanisms 220 to free the MU 100. For example, if the locking mechanisms 220 are retractable extensions, when the release mechanisms 225 are engaged, the locking mechanisms 220 descend into the dock 205. It should be noted that the locking mechanisms 220 and the release mechanisms 225 may be one unit. For example, the union may be on a hinge so that a solid extension (i.e., locking mechanisms 220) is received by slots on the MU 100. Through moving the union in a reverse pivot about the hinge (i.e., releasing mechanisms 225), the MU 100 may be released.

The docking walls 230 may provide supporting rests for the MU 100 upon being received by the mount 200. Specifically, the locking mechanisms 220 may provide a longitudinal securing of the MU 100 while the docking walls 230 may provide a lateral securing of the MU 100. The docking walls 230 may include the rails 235. The rails 235 may be received by the channels 130 of the MU 100. That is, the rails 235 may facilitate a proper reception of the MU 100 by the mount 200.

It should be noted that an exterior of the dock 205, the wearing mechanism 210, the locking mechanisms 220, the release mechanisms 225, the docking walls 230, and the rails 235 may be manufactured of an insulating material. That is, electrical signals may not be conducted therethrough. However, it should also be noted that electronic components may be disposed within the above described components. For example, the release mechanisms 225 may activate a solenoid to make the locking mechanisms 220 reverse the locking action.

The connection pads 240 may be areas disposed on a periphery of the mount 200 to establish a coupling to the antennas 125 of the MU 100. The connection pads 240 may be manufactured of a conducting material substantially similar to the material of the antennas 125. The connection pads 240 may be electrically connected to an internal circuitry of the mount 200. For example, the mount 200 may include a processor that interprets the inputs on the secondary data input arrangement 215. As described above, the antennas 125 may extend a partial length of the bottom side of the housing 105 of the MU 100. The bottom side extensions of the antennas 125 may be the portion that couples to the connection pads, thereby creating an electrical connection between the MU 100 and the mount 200.

FIG. 6 shows an assembled view of the MU 100 of FIGS. 3-4 coupled to the mount 200 of FIG. 5 according to an exemplary embodiment of the present invention. As discussed above, the mount 200 may receive the MU 100 to allow the MU 100 to be worn by a user. Also, as discussed above, the channels 130 may receive the rails 235 to facilitate a proper orientation for reception of the MU 100 by the mount 200. In addition, the locking mechanisms 220 may engage corresponding locking mechanisms disposed on the MU 100 to securely affix the MU 100 on the dock 205 of the mount 200. The locking mechanisms 220 may secure the MU 100 longitudinally while the docking walls 230 may secure the MU 100 laterally. Furthermore, the MU 100 and the mount 200 may be electrically coupled via the antennas 125 and the connection pads 240. When the MU 100 is received by the mount 200 and in a proper orientation, the antennas 125 may provide additional functionalities relative to the mount 200.

In a first exemplary embodiment, the antennas 125 may provide power to the mount 200. The mount 200 may include components (e.g., circuitry) that require a power supply. For example, the secondary data input arrangement 215 may require power. However, the mount 200 may not be equipped with its own portable power supply or connected to an external power supply. In addition, the MU 100 may be received by a variety of mounts so that the user may wear the MU 100 in a variety of locations. A conventional MU being received by a conventional mount utilizes a separate set of power contacts, thereby allowing the conventional mount to utilize the portable power supply of the conventional MU. According to the exemplary embodiments of the present invention, the antennas 125 may also provide the power to the mount 200. When the antennas 125 couple to the connection pads 240, power from the portable power supply of the MU 100 may be sent therethrough to the mount 200, thereby activating the components of the mount 200 that require energy. Thus, the separate set of power contacts located on both the conventional MU and the mount may be eliminated. For example, the DC powers 103-104 may be fed to the RF feed structure 101 that forwards the DC power to the antennas 125. Since the mount 200 is electrically coupled to the MU 100 via the antennas 125 and the connection pads 240, the DC power may be received by the mount 200. It should again be noted that the antennas 125 may still be enabled to carry out the conventional functionalities of antennas. That is, the RF chokes may isolate the antennas 125 from the DC power so that no interference is caused.

In another exemplary embodiment, the antennas 125 may provide a data connection between the MU 100 and the mount 200. As discussed above, the mount 200 may include components that send data signals. For example, the secondary data input arrangement 215 may be powered to allow a user to enter data. The data may be required to be input into the MU 100. A conventional MU and a conventional mount may include yet another set of data contacts to facilitate this exchange of data signals. According to the exemplary embodiments of the present invention, the antennas 125 may further provide the exchange of data signals. When the antennas 125 couple to the connection pads 240, data signals may be transmitted from the mount 200 to the MU 100 or from the MU 100 to the mount 200. Thus, the separate set of data contacts located on both the conventional MU and the mount may be eliminated. For example, the DC signals 103-104 may be fed to the RF feed structure 101 that forwards the DC signal to the antennas 125. Utilizing data over DC techniques that will be described in detail below, the data signals may be exchanged between the mount 200 and the MU 100. Again, it should be noted that the RF chokes may isolate the antennas 125 from the DC signals so that the antennas 125 may still execute the conventional antenna functionalities.

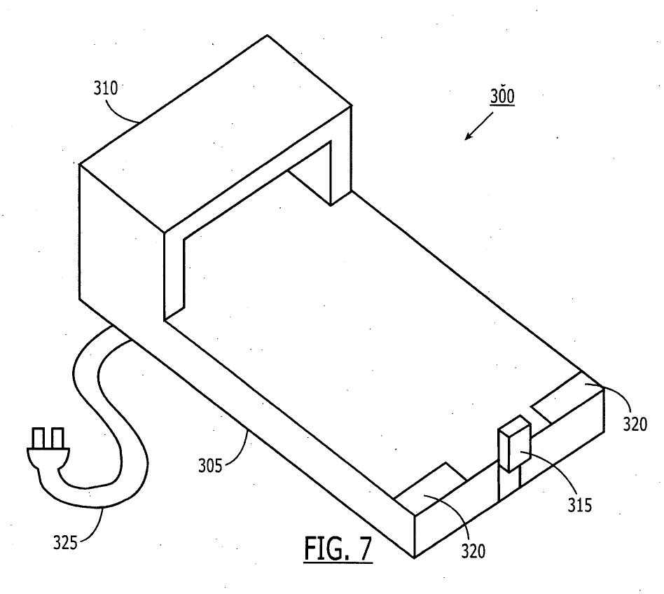

FIG. 7 shows a perspective view of a charger 300 that couples to the MU 100 of FIG. 3 according to an exemplary embodiment of the present invention. The charger 300 may be any device that provides a connection and converts energy from an external power supply for the MU 100. For example, the charger 300 may be a charging cradle. The charger 300 may include charger housing 305, a charger dock 310, a charger locking mechanism 315, charger connection pads 320, and an external power supply connector 325. It should be noted that the charger 300 may include further components such as a data input arrangement, a display, etc.

The charger housing 305 may at least partially encase the components of the charger 300. For example, the charger 300 may include a DC converter so that the external power supply may be properly converted before forwarding the energy to the MU 100 for recharging of the internal power supply. The DC converter may be entirely disposed within the charger housing 305. The charger dock 310, the charger locking mechanism 315, and the charger connection pads 320 may be disposed partially within the charger housing 305 and partially on the surface of the charger housing 305.

The charger dock 310 may provide a recess in which the MU 100 may be received. The charger dock 310 may further be configured so that when the MU 100 is received, the MU 100 is placed into a proper orientation in the charger 300. The charger locking mechanism 315 may ensure that the MU 100 stays coupled to the charger 300 (e.g., remain in the recess of the charger dock 310). The charger locking mechanism 315 may be a sliding lock so that a user may manually open the lock by pushing down so that the MU 100 may be received or removed from the charger 300.

The charger connection pads 320 may be substantially similar to the connection pads 240 of the mount 200. That is, the charger connection pads 320 may provide an electrical connection site for the charger 300. When the MU 100 is received by the charger 300 and in a proper orientation, the antennas 125 may be in a position so that an electrical contact is made with the charger connection pads.

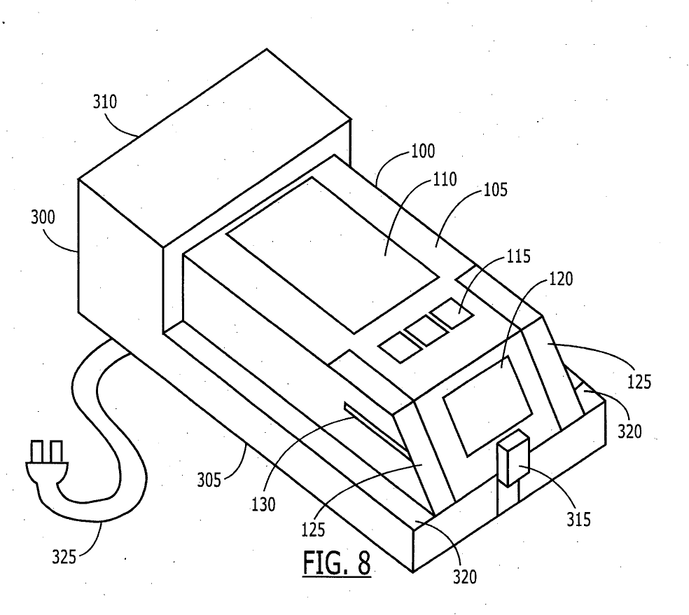

FIG. 8 shows an assembled view of the MU 100 of FIG. 3 coupled to the charger 300 of FIG. 7 according to an exemplary embodiment of the present invention. As discussed above, the charger 300 may receive the MU 100 to allow the internal power supply of the MU 100 to be recharged using an external power supply. Also, as discussed above, the charging functionality may be done using the antennas 125. That is, a separate set of charging contacts are not necessary for the MU 100 according to the exemplary embodiments of the present invention.

Those skilled in the art will understand that a conventional MU may include a set of charging contacts that interface with charging accessories (e.g., cradles, cabled power supplies, etc.) to recharge a portable power supply of the MU. The charging contacts require additional space within the conventional MU and increase the overall size. The additional set of charging contacts historically pose reliability issues as well. Furthermore, the repeated use of the set of charging contacts have led to the contacts to experience wear, easily break when the charging accessory is inadvertently removed, etc.

According to the exemplary embodiments of the present invention, the antennas 125 may act as the charging contacts. In a first exemplary embodiment, the antennas 125 may be electrically connected to the charger 300 via the charger connection pads 320. Thus, the external power received via the external power supply connector 325 may be converted and fed to the MU 100. For example, the DC may be received by the MU 100 via the antennas 125. The DC power may be forwarded to the RF feed structure 101. The DC power may be sent to a charging circuit of the MU 100 via the connections 103-104 so that the internal power supply is recharged.

It should be noted that data signals may also be exchanged between the MU 100 and the charger 300 using substantially similar data over DC techniques discussed above with reference to the coupling of the MU 100 with the mount 200 of FIG. 6. For example, the charger 300 may include a display indicating a power level of the internal power supply of the MU 100. The MU 100 may measure the power level and transmit this measurement as data using the data over DC technique to the charger 300 (e.g., using the electrical connection of the antennas 125 to the charger connection pads 320). It should also be noted that the antenna 125 may still be enabled to execute the conventional antenna functionalities while the charger 300 is recharging the internal power supply of the MU 100, exchanging data with the MU, etc.

FIG. 9 shows a schematic view of exemplary circuit components of the MU 100 of FIG. 3 (left hand side) coupled to the mount 200 of FIG. 5 (right hand side) according to an exemplary embodiment of the present invention. The schematic view may illustrate how a power and data connection may be established between the MU 100 and the mount 200 through a common connection via the coupling of the antennas 125 to the connection pads 240. It should be noted that the components shown in the schematic view are only exemplary and that further components may be included. It should also be noted that the right hand side being the mount 200 is only exemplary. As discussed above, the MU 100 may also couple to the charger 300 (e.g., third exemplary configuration). Thus, the following description also refers to this coupling.

The schematic view includes a left circuit and a right circuit. The left circuit may be the MU 100 while the right circuit may be the mount 200. The left circuit receives power from the portable power supply (in this exemplary case, a 5VDC power supply). The right circuit may receive power from the portable power supply through connection points J1 and J3. That is, the connection made between the antenna 125 (J1) and the connection pads 240 (J3). The DC exchanged may be used for the energy exchange and/or the data exchange discussed above. That is, for the data exchange, data over DC techniques are used.

The same connection may also provide a data connection between the left and right circuits. For example, a half-duplex (e.g., bi-directional, time divided, etc.) communication may be achieved across this connection. A resistor R2 of the left circuit may be placed in series with the portable power supply. This allows either circuit to affect the voltage level going through the connection points J1 and J3. It should be noted that this may require the right circuit to draw very low current. A voltage clamp in either the left or right circuits (denoted 3V clamp) may directly affect the voltage according to the transmitted data. The use of voltage clamping rather than a current sensing scheme eliminates at least half of the undesirable voltage swing caused by the right circuit. That is, the clamped voltage may be independent of the right circuit load. Consequently, the detection voltage margin may be increased. A voltage detector in either circuit (denoted detector) may produce an output corresponding to the transmitted data. A regulator (denoted voltage regulator) of the right circuit may isolate a control circuitry from the large voltage swings caused by the voltage clamps. The detector and the clamp drive FET may be internal to a microprocessor of either the MU 100 and/or the mount 200 to reduce the size and/or cost of integrating the circuitry.

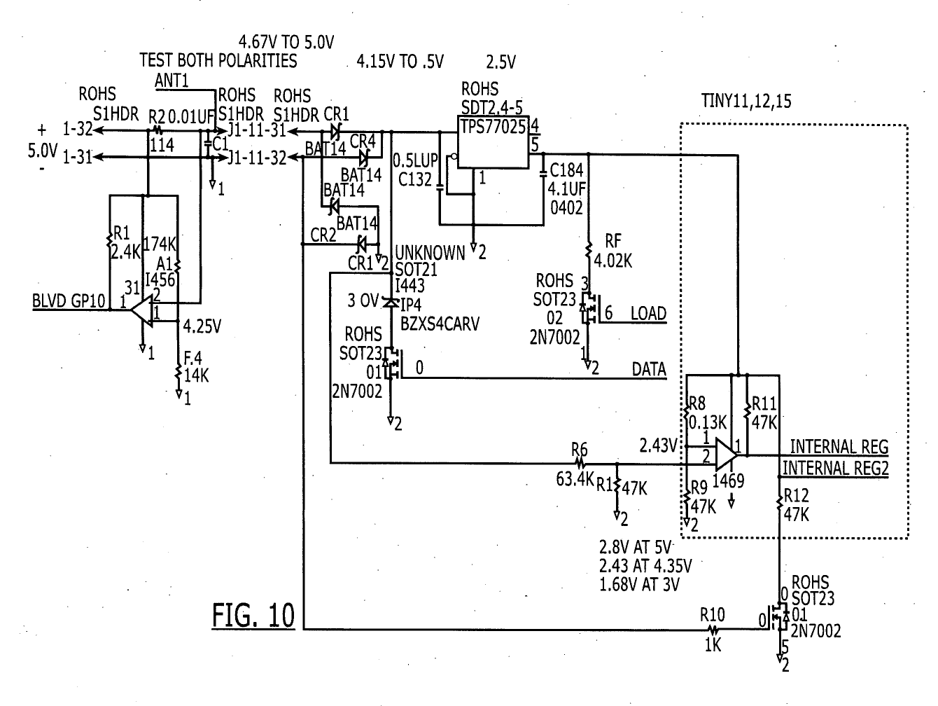

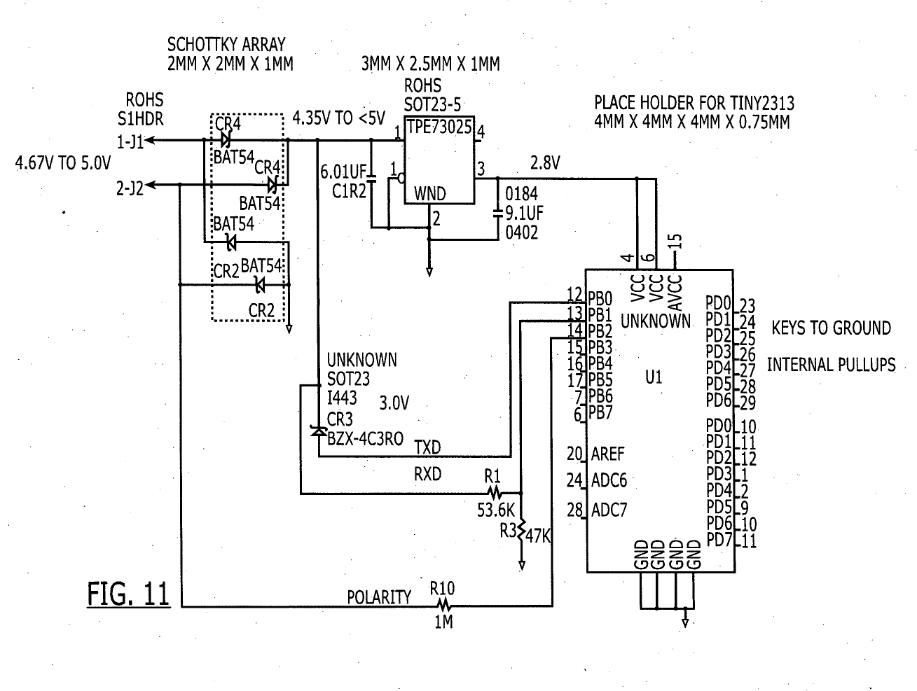

FIG. 10 shows an exemplary test circuit for data over direct current transfers according to an exemplary embodiment of the present invention. FIG. 11 shows an exemplary circuit for the mount 200 according to an exemplary embodiment of the present invention. It should be noted that the circuit of FIG. 11 may also be applied to the charger 300 during periods that the charger 300 is not charging. That is, FIG. 10 shows a test circuit on the right circuit that is used to simulate the mount 200 and/or charger 300, while FIG. 11 shows an actual circuit that may be used in the mount 200 and/or charger 300. A left side circuit may represent the MU 100. The right side circuit may represent the mount 200. The contacts directed at each other may be the antenna 125 of the MU 100 and the connection pads 240 of the mount 200. The RF energy is shunted to ground. A microprocessor may be disposed in the mount 200 to scan for key input. When a key is pressed, a hardware interrupt may be generated on a general purpose input/output of the microprocessor of the MU 100 causing a driver of the operating system of the MU 100 to run. The driver may then request the key status from the microprocessor of the mount 200.

A 330 ohm resistor may be low enough in value to allow up to 2 mA to flow into the microprocessor without dropping excessive voltage. For example, the Atmel Tiny 2313 is rated at 230 μA at 1.8V at 1 MHz clock. Q1 is shown as included in the circuit of FIG. 10 but may be internal to the mount microprocessor as is the case with the carrier circuit of FIG. 11. When Q1 is off (or when the actual mount microprocessor of FIG. 11 has an output that is high or an open drain), there is not enough voltage across CR5 to cause any conduction. Thus, the voltage drop across R2 in the MU 100 will be small. Comparator U1 of the MU 100 may detect this condition as a logic level high.

When Q1 turns on, zener CR5 clamps to 3.0V. Comparator U1 detects this low voltage (allowing for 2 Schottky drops through the bridge having Schottky diodes labeled CR 1-4) as a logic level low. For testing purposes, Q1 and Q2 may be turned on and off with function generators, while R5 simulates the load from the mount microprocessor. Q1 simulates an internal FET of the mount microprocessor. Those skilled in the art will understand that the above and below described components including the component values are only exemplary. There are other circuit configurations including different component and component values that may be used to accomplish the same functionality.

According to an exemplary embodiment of the present invention, the MU 100 may be coupled into the mount 200 in multiple directions. The multiple directions may result in multiple polarities of power/data signals being received from the MU 100 by the mount 200. A bridge may be used to provide a single polarity to the right side circuit. The illustrated full wave Schottky bridge includes CR1, CR2, CR3, and CR4 and typically drop under 300 mV. Thus, the 3.0V zener clamp causes about 3.6V on the MU 100 side of the bridge (e.g., 3.0 V for zener CR5 and 0.3V for two of CR1-CR4). The full wave Schottky bridge may be replaced with a full wave FET bridge to reduce the drop to near zero. The full wave FET bridge may consist of 2 N-channel and 2 P-channel FETs in an H-shape configuration.

The comparator U1 threshold may be set to any value to distinguish between the logic high and low. In the exemplary embodiments, a value of 4.25V was used. An analysis may be performed to determine the ideal voltage by considering a maximum mount microprocessor current, noise on VCC5 caused by current pulses into other subsystems, zener clamping voltage tolerance and temperature dependence, and Schottky drop over temperature. Although a 3.0V zener noise margin may be high, the exemplary Atmel Tiny 2313V processor may work down to 1.8V. Thus, in one exemplary embodiment, the 3.0V zener was used in conjunction with a 2.8V regulator. In another exemplary embodiment, a 2.0V regulator is used with a 2.2V zener, thereby adding another 800 mV of margin.

FIG. 10 illustrates a data over DC technique to send logic levels from the mount 200 to the MU 100. However, by applying a corresponding voltage clamp on the side of the MU 100, the mount 200 may detect data from the terminal, thereby allowing bi-directional data exchange between the MU 100 and the mount 200. It should be noted that the mount 200 side would also need to implement a corresponding component to detect voltage levels. Thus, a comparator may be integral to the mount microprocessor or a separate component.

As described above, the polarity of the signals received from the MU 100 may change based on how the MU 100 is inserted into the mount 200. Thus, a polarity sensing circuit may also be implemented in the mount 200 circuit. For example, R10 may tap the input side of the bridge which may either be a Schottky drop from ground or over regulator voltage depending on the polarity. The mount microprocessor may have input protection diodes. R10 may be high enough not to pass significant current that causes the regulator output voltage to increase. A small current (e.g., <10 microA) will flow, which is much less than the microprocessor VCC current and will, therefore, not back bias the regulator.

The upper limit of a maximum baud may be set by the amount of capacitance that exists at the ANT1 node (i.e., one of the antennas 125) and at the regulator input. Regulator data sheets typically show a 1 μF or larger capacitance on the input (e.g., to increase performance, to increase stability, etc.).

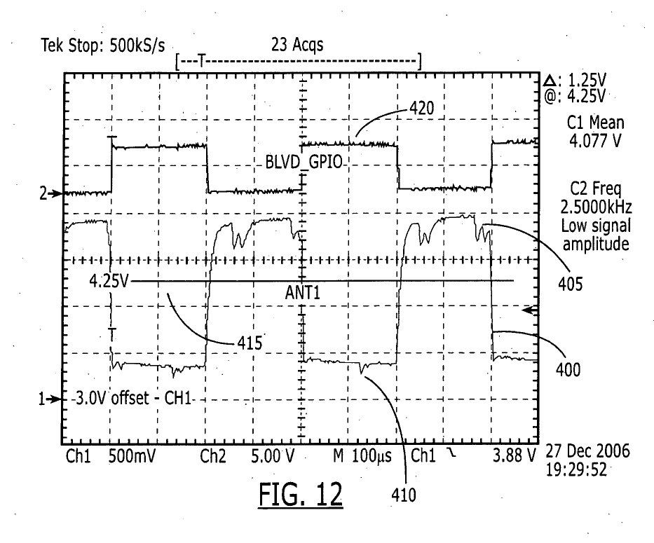

FIG. 12 shows a first graph of signals for a data over DC technique according to an exemplary embodiment of the present invention. The first graph will be described with reference to the circuits of FIG. 10. The first graph shows a signal 400 at the ANT1 node as the zener anode is switched to ground at 2.5 kHz. The first graph also shows a detected signal 420 that will be received by the general purpose input/output of the processor of the MU 100. The small dips (e.g., in an area 405 of the signal 400) may be caused by the simulated load current at a much higher frequency. That is, the test to generate the signal 400 is based on the simulated mount circuit of FIG. 10. The signal 400 is easily detected by the comparator (channel 2). The threshold was set to 4.25V which was not centered so that more margin is available. That is, signal 400 is shown to be substantially greater than a line 415 indicating the comparator threshold of 4.25V, meaning that the comparator will be able to detect changes from the logic low to the logic high and vice versa. The first graph also shows that the dips (e.g., in an area 410 of the signal 400) caused by the simulated mount microprocessor current are not as large when the zener CR5 is clamping.

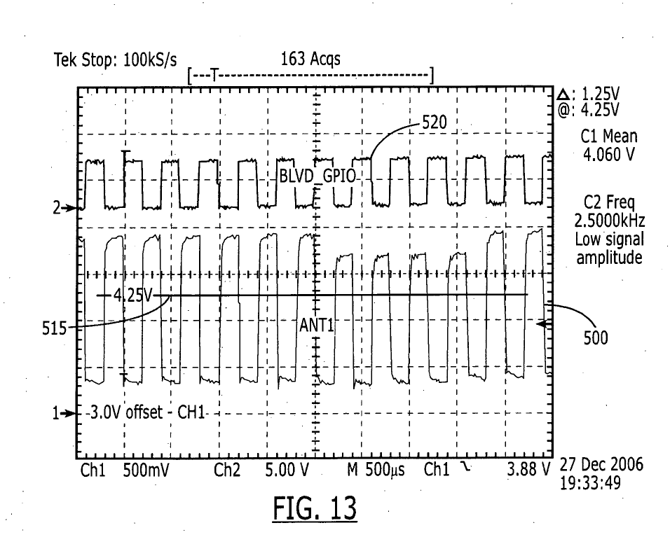

FIG. 13 shows a second graph of signals for a data over DC technique according to an exemplary embodiment of the present invention. The second graph will also be described with reference to the circuit of FIG. 10. The second graph shows a signal 500 at the ANT1 node and a detected signal 520 when the load current is at a lower frequency than the data frequency. Again, the signal 500 is easily distinguishable using the 4.25V comparator threshold 515.

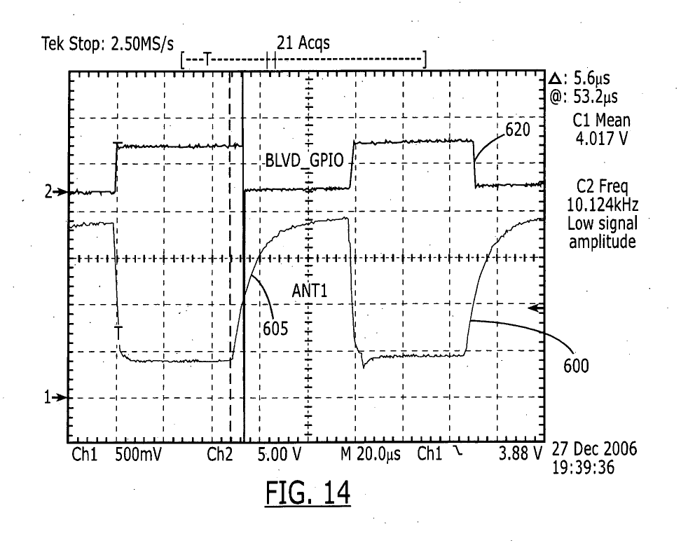

FIG. 14 shows a third graph of signals for a data over DC technique according to an exemplary embodiment of the present invention. The third graph will also be described with reference to the circuit of FIG. 10. The third graph shows a signal 600 at the ANT1 node and a detected signal 620. However, the third graph also shows that a capacitance at the regulator input may cause a delay in the voltage rise when the zener CR5 is unclamped as shown in an area 605 of the signal 600. However, the rise is still sufficient to satisfy the comparator threshold. Thus, the data is easily transferred at 10.124 kHz as shown in the graph of FIG. 14.

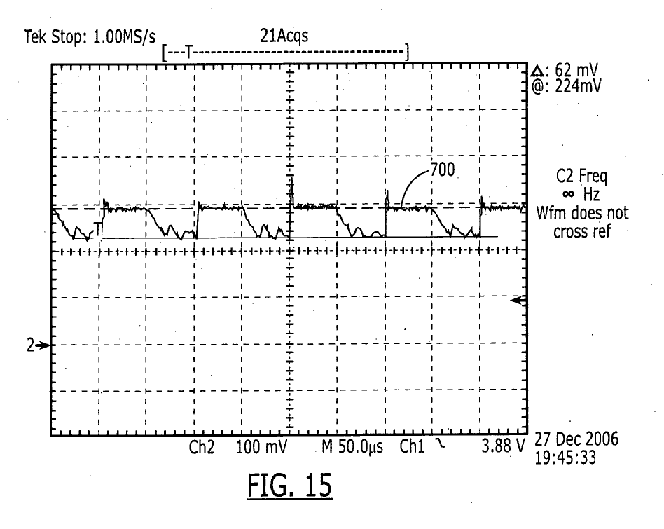

FIG. 15 shows a fourth graph of signals for a data over DC technique according to an exemplary embodiment of the present invention. The fourth graph will be described with reference to the circuit of FIG. 10. The fourth graph shows the signal 700 indicating the Schottky drop across CR1 of the bridge as the data is sent across the link.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a housing; and
an external antenna disposed at least partially on the housing, the external antenna conforming to the housing, the external antenna configured to one of receive wireless data signals and transmit wireless data signals, the external antenna being further configured to conduct power signals.

2. The mobile device of claim 1, further comprising:
a circuit electrically coupled to the external antenna, wherein the power signals include data, the data being transmitted to a processor of the mobile device via the circuit.

3. The mobile device of claim 2, wherein the circuit includes at least one comparator, at least one voltage clamp and a series resistance.

4. The mobile device of claim 3, wherein the external antenna is a single wire pair.

5. The mobile device of claim 4, wherein the circuit includes a full wave diode bridge allowing a polarity of the single wire pair to be reversed.

6. The mobile device of claim 5, further comprising:
a detector detecting the polarity.

7. The mobile device of claim 5, wherein the circuit further comprises four field-effect transistors reducing a voltage across the bridge.

8. The mobile device of claim 1, wherein the external antenna couples to contacts of a charging accessory to receive the power signals to charge a battery of the mobile device.

9. The mobile device of claim 1, wherein the wireless data signals one of connect to a network, perform a radio frequency identification application, and perform a positioning application.

10. The mobile device of claim 1, wherein the external antenna is a wearing plate disposed in a location of heavy wear of the mobile device.

11. The mobile device of claim 1, wherein the mobile device is received by a wearable mount.

12. The mobile device of claim 11, wherein the wearable mount is worn on at least one of a finger, a wrist, and a waist.

13. The mobile device of claim 11, wherein the external antenna couples to a connection pad of the wearable mount.

14. The mobile device of claim 13, wherein the external antenna provides the power signals to the mount via the connection pad.

15. The mobile device of claim 1, wherein the external antenna is disposed on the housing by being one of insert molded, inserted mechanically during manufacture, heat staked, adhered, transfer taped, plated directly to the housing, and a combination thereof.

16. A mount, comprising:
a dock receiving a mobile device; and
a connection pad coupling to an external antenna of the mobile device, the coupling being used for transmission of data and power signals between the mount and the mobile device.

17. The mount of claim 16, further comprising:
a full wave diode bridge circuit allowing the mount to receive the data and power signals having any polarity.

18. The mount of claim 17, further comprising:
a circuit detecting the polarity of the data and power signals.

19. The mount of claim 17, wherein the full wave diode bridge circuit includes four field effect transistors.

20. The mount of claim 16, further comprising:
a data input arrangement.

21. The mount of claim 20, wherein the data signals transmitted from the mount to the mobile device includes a status of the data input arrangement.

22. The mount of claim 20, wherein the data input arrangement is powered by the power signals received from the mobile device.

23. The mount of claim 16, further comprising:
a wearing mechanism to affix the mount to a body location, the wearing mechanism being one of straps, a ring, and a clip.

24. A mobile device, comprising:
a housing; and
a transmitting means for receiving one of wireless data signals and transmitting wireless data signals, the transmitting means further configured for receiving power signals, the transmitting means being disposed at least partially on the housing, the transmitting means conforming to the housing.

25. A mount, comprising:
a receiving means for receiving a mobile device; and
a connecting means for coupling to a transmission means of the mobile device, the connecting means being used for transmission of data and power signals between the mount and the mobile device.
